(19) United States
(12) Patent Application Publication
(10) Pub. No.: US 2012/0256011 A1
(43) Pub. Date: Oct. 11, 2012

(54) METHOD OF HIGH FLOW GAS DIFFUSION

(75) Inventors: Harold Kinasewich, Edmonton (CA); Kyle Greene, Edmonton (CA); Todd Webb, Tofield (CA)

(73) Assignee: SEAIR INC., Edmonton, AB (CA)

(21) Appl. No.: 13/517,452

(22) PCT Filed: Dec. 21, 2010
(86) PCT No.: PCT/CA2010/001993

§ 371 Date: Jun. 20, 2012

(30) Foreign Application Priority Data
Dec. 21, 2009 (CA) ,2689,171

(51) Int. Cl. B01F 3/04

(52) U.S. Cl. 239/8

(57) ABSTRACT

A method of high flow gas diffusion is described involving the following steps. Firstly, positioning at least one diffuser in an upper portion of a vessel. Secondly, filling the upper portion of the vessel with a gas to create a gas zone. Thirdly, passing a liquid through the at least one diffuser to create at least two liquid streams that impinge upon each other in the gas zone in a shearing action that causes the liquid to interact with the gas. Fourthly, collecting and removing treated liquid from a lower portion of the vessel.

### FIELD

There is described a method of high flow aeration to facilitate the addition of gas to a liquid stream.

### BACKGROUND

U.S. Pat. No. 7,137,620 is a prior patent by Seair Inc which discloses an aeration apparatus in which air bubbles are injected into a stream of flowing liquid and then the stream of flowing liquid is passed through a diffuser which divides the liquid into impinging streams. While beneficial results have been obtained through the use of the apparatus described in the patent, it has been found to have limitations, the most significant of which is the flow rate through the diffuser.

### SUMMARY

According to an aspect, there is provided a method of high flow gas diffusion which involves the following steps. Firstly, positioning at least one diffuser in an upper portion of a vessel. Secondly, filling the upper portion of the vessel with gas to create a gas zone. Thirdly, passing a liquid through the at least one diffuser to create at least two liquid streams that impinge upon each other in the gas zone in a shearing action that causes the liquid to interact with the gas. Fourthly, collecting and removing aerated liquid from a lower portion of the vessel.

According to another aspect, the gas may be injected into the upper portion of the vessel under positive pressure.

According to another aspect, there may be three or more liquid streams that impinge upon each other at a common point. The common point may be a two or three dimensional line in the upper portion.

According to another aspect, there is provided a high flow gas diffusion apparatus, comprising a vessel having an upper portion, a lower portion, a gas inlet in the upper portion and a liquid outlet in the lower portion, and at least one diffuser positioned in the upper portion of the vessel, the at least one diffuser having at least two flow openings that discharge upon a common point. A pump injects liquid under pressure up a riser pipe to the diffuser. A first coupling couples the pump to a source of liquid. A second coupling couples the gas inlet to a pressurized source of gas. A third coupling couples the liquid outlet to flow conduit.

According to another aspect, there may be three or more flow openings that discharge upon a common point, and the common point may be a two or three dimensional line in the upper portion.

As will hereinafter further described, the method described above facilitates higher flow rates and provides other important benefits.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a gas diffusion apparatus constructed in accordance with the teachings of the present method.

FIG. 2 is a detailed side elevation view in section of the vessel from the gas diffusion apparatus illustrated in FIG. 1.

### DETAILED DESCRIPTION

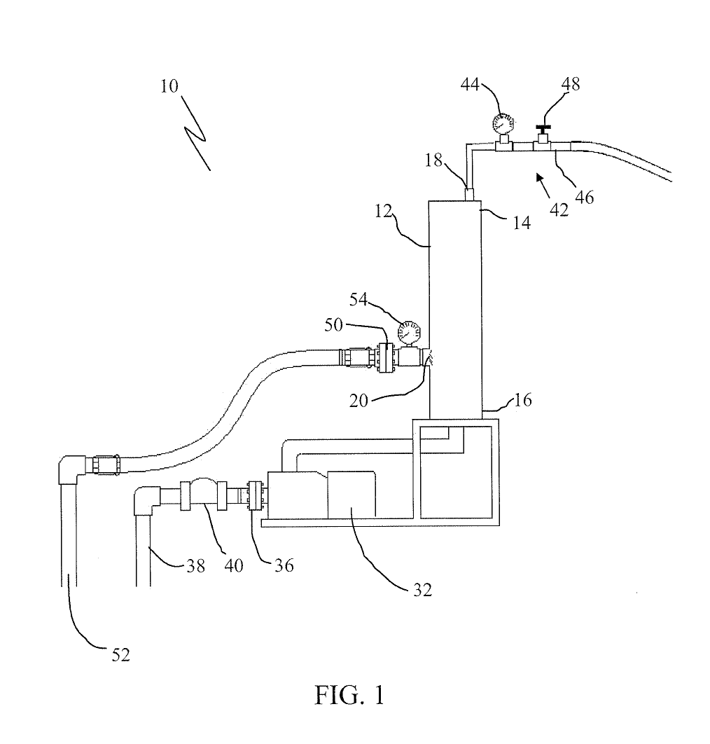

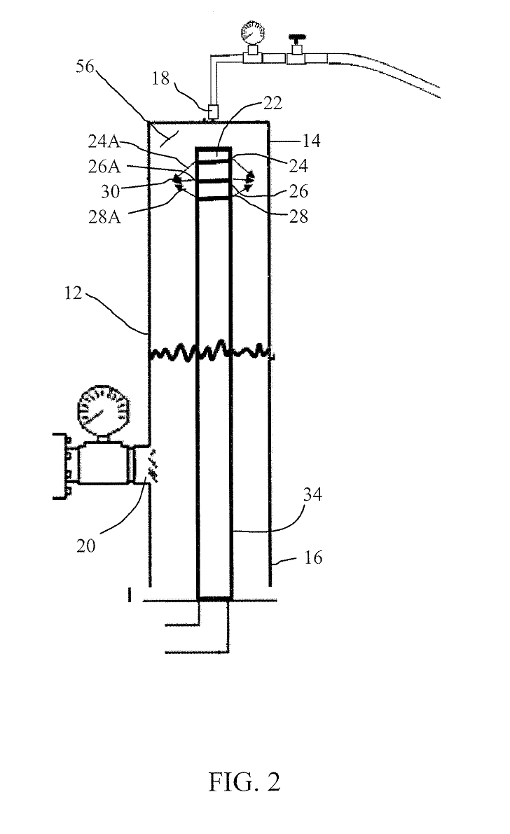

A method of high flow gas to fluid transfer will now be described with reference to FIGS. 1 and 2.

### Structure and Relationship of Parts:

Referring to FIG. 2 a gas diffusion apparatus, developed in accordance with the teachings of the method generally identified by reference numeral 10, will first be described. Gas diffusion apparatus may be used to transfer air or oxygen into a liquid, such as water to be treated. In those circumstances, the apparatus may be referred to as an aeration apparatus. However, it will also be understood that gas diffusion apparatus 10 may also be used to transfer other gases, or mixtures of gases, into different liquids, depending on the preferences of the user and the circumstances of its use. Accordingly, when the term “gas” is used herein, it is intended to cover the various gases or mixtures of gas that may be used, and the term “liquid” is intended to cover the various liquids or mixtures of liquid that the gas may be injected into.

Gas diffusion apparatus 10 includes a vessel 12 having an upper portion 14, a lower portion 16, a gas inlet 18 in upper portion 14 and a liquid outlet 20 in lower portion 16. A diffuser 22 is positioned in upper portion 14 of vessel 12. Diffuser 22 is shown with three flow openings 24, 26, and 28 that discharge upon a common point, indicated by reference numeral 30. Common point 30 may not be a single point, but may instead be a two or three dimensional line that extends through upper portion 14. The diffuser 22 that has been illustrated is one that was previously developed and was the subject of U.S. Pat. No. 7,137,620. Once the teachings of the method is understood, it will be appreciated that there need not be three flow openings, that beneficial results may be obtained through the use of only two openings, or through the use of more than three openings. It will also be appreciated that a separate diffuser may be used for each stream, as long as each stream is discharged upon a common focal point 30. It will also be appreciated that several focal points with several diffusers could also be used. Referring to FIG. 1, a pump 32 is provided. Referring to FIG. 2, pump 32 is used to inject liquid under pressure up a riser pipe 34 to diffuser 22. Referring to FIG. 1, a first coupling in the form of a coupling flange 36 is provided for coupling pump 32 to a conduit 38 connected to a source of liquid (not shown), which will generally be untreated. Conduit 38 preferably has a check valve 40 which allows flow in only one direction through pump 32 to riser pipe 34. A second coupling, generally identified by reference numeral 42, is provided for coupling gas inlet 18 to a pressurized source of gas (not shown). Second coupling 42 may include a pressure gauge 44 to measure inlet pressure, a check valve 46 to limit flow to one direction that being into vessel 12, and a needle valve 48 to allow variable pressure and flow of gas into vessel 12 as well for vessel 12 to be isolated from the pressurized source of gas. A third coupling in the form of a coupling flange 50 is provided for coupling liquid outlet 20 to a discharge conduit 52. It is preferred that a pressure gauge 54 be placed upstream of coupling flange 50 to provide a reading on pressure levels within vessel 12.

### Operation:

A first step involves setting up gas diffusion apparatus 10 in preparation for operation, as described above, with diffuser 22 positioned in upper portion 14 of vessel 12. A second step involves filling upper portion 14 of vessel 12 with a gas to create a gas zone, generally indicated by reference numeral 56. This is accomplished by connecting a source of pressurized gas (not shown) to second coupling 42. For the aeration of water, the aeration gas would be air or oxygen. For treatment of other liquids, other gases or mixtures of gases may be used. Pressure gauge 44 will indicate the positive pressure that gas inlet 18 is being placed under by the pressurized gas source. A third step involves passing a liquid, which will generally be not treated, through diffuser 22 to create three liquid streams 24A, 26A and 28A flowing through flow openings 24, 26, and 28 that discharge upon a common focal point 30. Liquid streams 24A, 26A and 28A impinge upon each other at focal point 30 in gas zone 56 in a shearing action that causes the liquid to interact with the gas. A fourth step involves collecting and removing treated liquid from lower portion 16 of vessel 12. This occurs by outflow through liquid outlet 20 to discharge conduit 52.

### Advantages:

The described method has been found to provide the following advantages over the aeration apparatus described in U.S. Pat. No. 7,137,620.

Flow Rate—A greater flow rate can be achieved by passing a liquid through the diffuser. In the prior art, as flow rates increased, the injector created a flow restriction when a gas was added upstream of the diffuser. It will also be appreciated that a lower flow rate is also possible.

Pressure Ranges—The method allows operation at lower pressures as low as 1 or 2 pounds per square inch (psi). In the prior art, aeration through the diffuser required there to be a pressure differential over 20 pounds per square inch (psi) or more. At pressures lower than 20 psi, the prior art aeration apparatus ceased to operate as there was insufficient suction through the venturi. It will be appreciated that the method can also operate at higher pressures, when application requirements demand the same.

Continuous Cycling—By repeatedly cycling liquid from a liquid source, the present method allows treatment levels of the liquid to be increased over time. In the prior art, the diffuser served to degas the liquid stream and block higher levels of oxygen addition.

Increased Efficiency—Operating at higher flow rates and lower pressures is far more efficient than was possible with the prior art.

Simplification—The fact that the present method requires flow, but not the same degree of pressure differential simplifies the apparatus and reduces maintenance requirements.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. A method of high flow gas diffusion, the method comprising the steps of:
positioning at least one diffuser in an upper portion of a vessel;
filling the upper portion of the vessel with a gas to create a gas zone;
passing a non-aerated liquid through the at least one diffuser to create at least two liquid streams that impinge upon each other in the gas zone in a shearing action that causes the liquid to interact with the gas; and
collecting and removing the aerated liquid from a lower portion of the vessel.

2. The method of claim 1, further comprising the step of injecting the gas into the upper portion of the vessel under positive pressure.

3. The method of claim 1, further comprising the step of utilizing three or more liquid streams that impinge upon each other.

4. The method of claim 3, wherein the three or more liquid streams impinge upon each other at more than one impingement point.

5-7. (canceled)
